(19) United States
(12) Patent Application Publication
(10) Pub. No.: US 2017/0175418 A1
(43) Pub. Date: Jun. 22, 2017

(54) MATES KEYS

(71) Applicant: Kaba IIco Corp., Rocky Mount, NC (US)

(72) Inventors: Glenn Merlen, Rocky Mount, NC (US); Lynn Best, Wilson, NC (US); Dustin Hunter, Wake Forest, NC (US)

(21) Appl. No.: 15/386,992

(22) Filed: Dec. 21, 2016

Related U.S. Application Data
(60) Provisional application No. 62/270,640, filed on Dec. 22, 2015.

(51) Int. Cl. E05B 19/04; E05B 19/24

(52) U.S. Cl. CPC E05B 19/04; E05B 19/24

(57) ABSTRACT

The present disclosure provides mates keys and mates key bows having respective mating surfaces disposed on respective bows, as well as sets of keys configured to physically mate with one another by way of respective mating surfaces defined on respective bows of the keys. Each of the mates keys comprises a blade portion, which may be bitted to match a given lock, and a bow portion attached to the blade portion which can be mated to a bow portion of another mates key. When physically mated, the bow portions of two or more keys are physically fitted together to form a visual based on respective visuals on the mates key bows.

### CROSS-REFERENCE TO RELATED APPLICATIONS

This application claims priority from U.S. provisional patent application No. 62/270,640, filed Dec. 22, 2015, the entire content of each of which is incorporated by reference herein.

### TECHNICAL FIELD

The present invention relates generally to keys, and more specifically to sets of keys which mate with one another to form a bow-to-bow design/shape.

### BACKGROUND OF THE ART

The use of keys is widespread in almost all societies as tools for limiting or granting access to certain locations or certain goods, and indeed keys have been used since antiquity. Keys may be used to lock doors or safes, or may work in association with a padlock for securing objects, such as bikes, and the like.

Modern keys traditionally combine two components, namely a blade portion and a bow portion, with the blade portion being attached to the bow portion. The blade portion is typically elongated and may include one or more bittings and a tip. The bow portion is typically wider than the blade portion, and allows a user to hold the key and apply a torque to turn the key in a lock or locking mechanism. Modern keys come in a variety of shapes and sizes, and in some cases certain sets of keys may present common design characteristics, such as common colors or paint, or common shapes.

While keys with specific designs are popular, there may be an interest in sets of keys which combine or mate with one another to further demonstrate their belonging to a common set.

### SUMMARY

The present disclosure provides mates keys and mates key bows having respective mating surfaces disposed on respective bows, as well as sets of keys configured to physically mate with one another by way of respective mating surfaces defined on respective bows of the keys. Each of the mates keys comprises a blade portion, which may be bitted to match a given lock, and a bow portion attached to the blade portion which can be mated to a bow portion of another mates key. When physically mated, the bow portions of two or more keys are physically fitted together to form a visual based on respective visuals on the mates key bows.

In accordance with a broad aspect of the present disclosure, there is provided a mates key. The mates key comprises a blade portion; and a bow portion connected to the blade portion and comprising a first visual, the bow portion defining at least one mating surface configured for physically mating with at least one corresponding mating surface of a corresponding bow portion of a second mates key; the bow portion of the mates key and the corresponding bow portion of the second mates key forming a second visual, including the first visual, when physically mated.

In accordance with a further broad aspect of the present disclosure, there is provided a set of mates keys. The set of mates keys comprises a plurality of mates keys including at least a first mates key and a second mates key. Each of the mates key comprises a blade portion; and a bow portion, connected to the blade portion, defining at least one mating surface and comprising a visual; the at least one mating surface of the first mates key being physically mateable with a corresponding one of the at least one mating surface of the second mates key to form a second visual including at least the visual of the first mates key and the visual of the second mates key

In accordance with a further broad aspect of the present disclosure, there is provided a mates key bow. The mates key bow comprises a first visual located on the mates key bow; and at least one mating surface configured for physically mating with at least one corresponding mating surface of a corresponding mates key bow to form a second visual, including the first visual, when physically mated

Like symbols are of a same image, number, shape, color, theme, etc. Other embodiments for mating keys will be readily understood by those skilled in the art.

### DETAILED DESCRIPTION OF THE DRAWINGS

Further features and advantages of embodiments described herein may become apparent from the following detailed description, taken in combination with the appended drawings, in which:

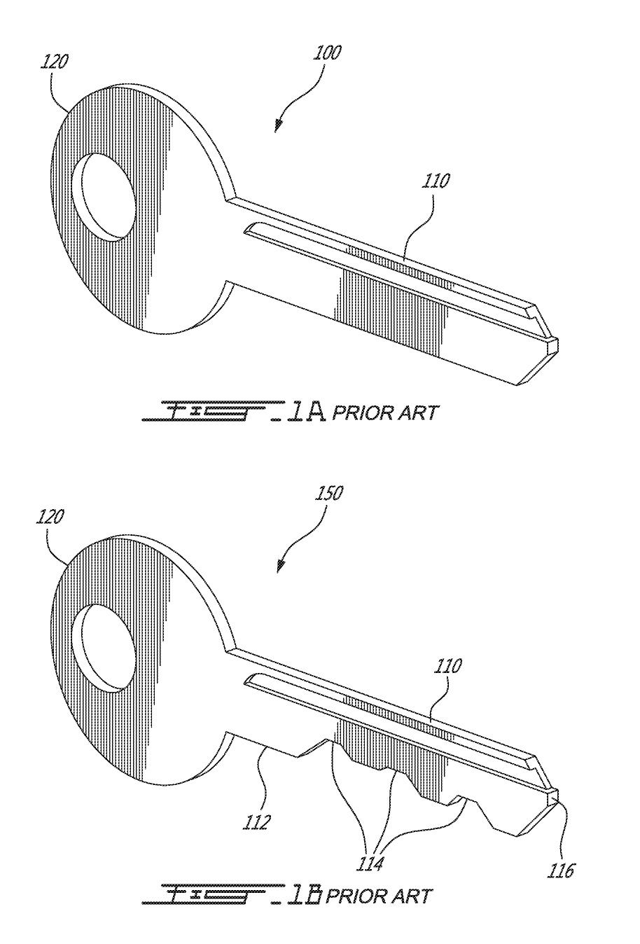

FIGS. 1A-B are side views of a standard prior art blank and bitted key.

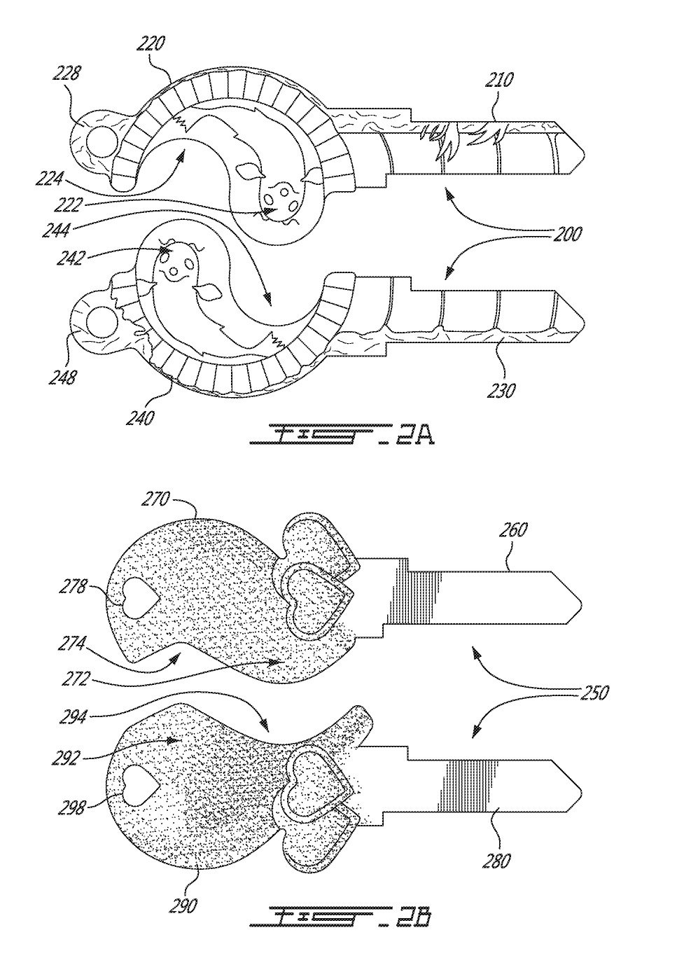

FIGS. 2A-B are side views of embodiments of pairs of mating keys comprising curved mating components within the context of the present disclosure.

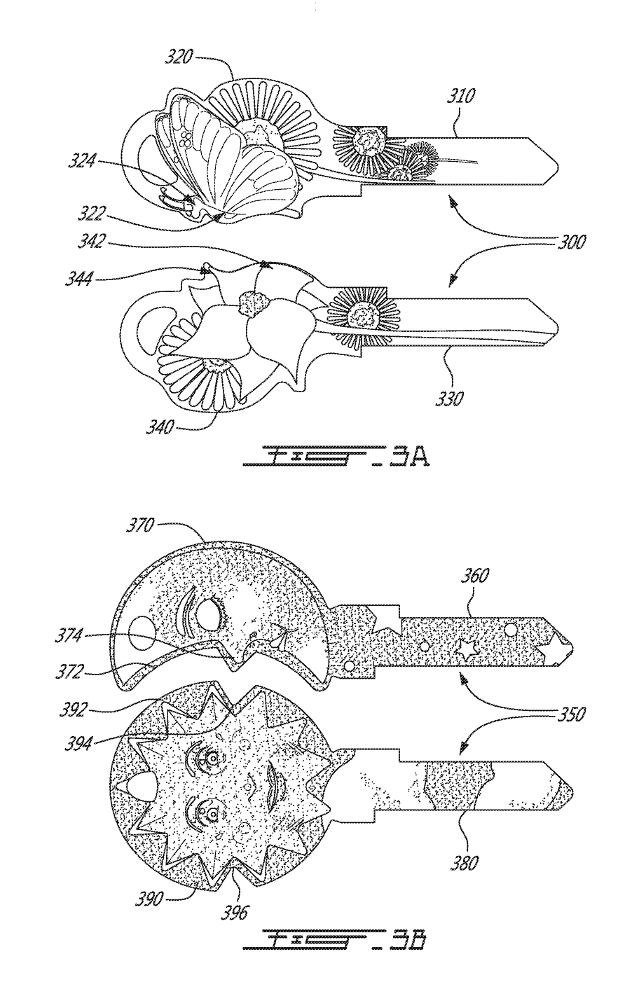

FIGS. 3A-B are side views of embodiments of pairs of mating keys comprising pointed mating components within the context of the present disclosure.

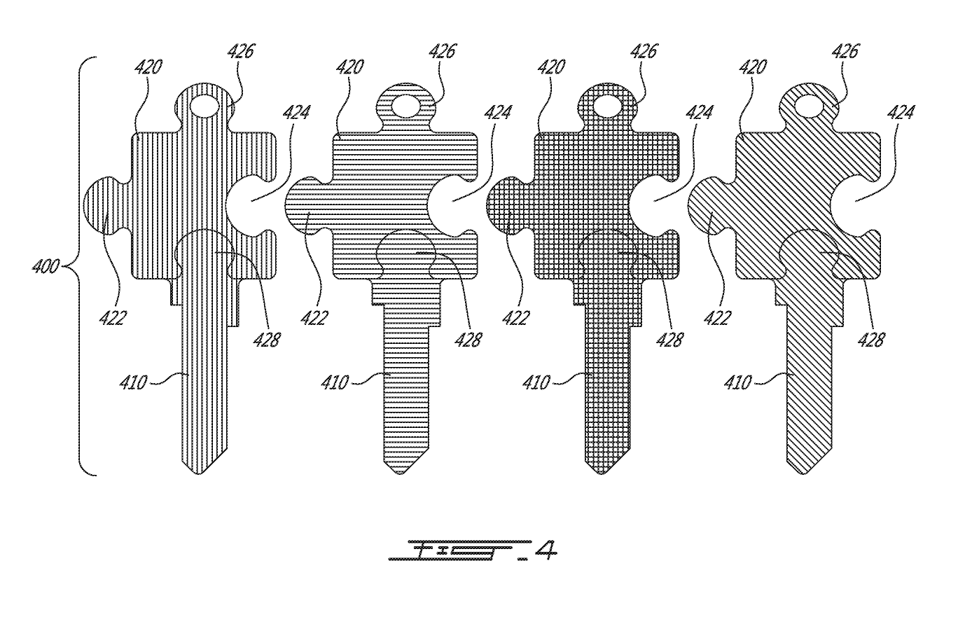

FIG. 4 is a side view of an embodiment of a set of mating keys where more than two counterpart keys may be mated together.

It will be noted that throughout the appended drawings, like features are identified by like reference numerals.

### DETAILED DESCRIPTION

With reference to FIGS. 1A-B, there are shown standard key blanks for keys. FIG. 1A shows an unbitted blank 100 comprising a blade portion 110 and a bow portion 120, connected to the blade portion 110. The blade portion 110 is narrow and elongated, and is configured to be bitted. The bow portion 120 is generally wider than the blade portion 110, and is the portion held by a user of the key to apply a torque to the key when used in combination with a lock (not illustrated). The bow portion 120 may come in a variety of shapes and sizes, and the unbitted blank 100 may come in a variety of colours and paints. Additionally, the unbitted blank 100 may be made with any suitable material, including plastics, for example rigid or durable plastics, metal, for example brass, steel, aluminium, and the like, or any other suitable material.

The unbitted blank 100 may be formed via a blanking process whereby the unbitted blank 100 is punched out of a strip of sheet of the particular material of which the unbitted blank 100 is produced. For example, the unbitted blank 100 is formed by punching out the unbitted blank 100 from a sheet of steel or other suitable metal. In certain embodiments, the unbitted blank 100 is also milled to give the unbitted blank an appropriate form factor to match a particular lock type, or for any other suitable reason.

FIG. 1B illustrates the unbitted blank 100 after being bitted, which may be a key 150. The key 150 comprises the blade portion 110 and the bow portion 120 connected to the blade portion 110, but the blade portion 110 has been bitted to a certain pattern to match at least one lock. Specifically, the blade portion 110 has been bitted to form a shoulder 112, at least one bitting 114, and a tip 116. While it should be noted that in some cases the blade portion 110 may be bitted to have only one such bitting 114, in many embodiments the key 150 will comprise a plurality of bittings. Additionally, while the shoulder 112 and tip 116 are only illustrated as being present in the key 150 (i.e., not in the unbitted blank 100), it should be noted that certain variations of the unbitted blank 100 may have a defined shoulder and tip, for example via a milling process. In some further embodiments, a coining process is applied to the key to apply a logo or other design or image to the key 150.

Traditional blanks and keys, including those shown in FIGS. 1A-B, typically may not allow for a user to determine if any belong to a set or share a common purpose, for example opening a common lock. Similarly, where a group of individuals are each provided with a key for a certain purpose, the provided keys are typically not distinguishable from any other keys the individuals may already have in their possession. The present disclosure relates blanks and keys which can be mated with one-another via their bow portions, hereinafter referred to as “mates keys”. The expressions “mates key” and “mates keys” are herein intended to generally refer to both the blanks or the keys after the blanks have been bitted

Specifically, mates keys are key blanks or keys which may be physically and removably mated together via their respective bow portions by way of mating surfaces located on the respective bow portions, such that such a mating surface located on a first mates key may be complementarily joined with a mating surface located on a second mates key of the same set. The mating surfaces may be complementarily joined by sliding one against or into the other, or by interlocking, snapping, pressing, or pushing one against the other or into the other, or by any other suitable means. Put differently, the mates keys may be joined via a mechanical fastening, via form fitting, or by a side-by-side placement. Thus, in certain embodiments, the bow portion of a given mates key comprises at least one substantially concave and/or at least one substantially convex mating surface, and the at least one substantially concave mating surface of the first mates key is configured for complementarily joining with the at least one substantially convex mating surface of the second mates key, or vice-versa. The mating surfaces may be located on a periphery of the bow portion of the mates key, for example along a perimeter thereof, or may be located within the perimeter of the bow portion, for example in a central or off-centre area of the bow portion of the mates key. A ringhole (not illustrated) present on a mates key may also be used as a mating surface. In some embodiments, as will be discussed below, the mating surfaces may extend from a plane defined by the perimeter of the bow portion. In certain other embodiments, the bow portion of a given mates key is mateable with the bow portion of another mates key by aligning or bringing together the respective bow portions.

In so mating, or complementarily joining, the respective bow portions of the first and second mates keys may combine to form an image, shape, symbol, design, etc., or of any other suitable visual which may be a more complete visual based on a plurality of incomplete visuals. More specifically, the bow portion of the first mates key may feature a first visual that is a first portion of the complete visual and the bow portion of the second mates key may feature a separate visual that is a second portion of the complete visual. The complete visual can then be completed by mating the first and second mates keys via their bow portions.

Thus, each mates key may have a stand-alone visual which when combined with an associated stand-alone visual of another mates key form a second visual which includes the stand-alone visual of each mates key. In this way, when the first mates key is not joined with any further mates keys, a first visual on the first mates key may be incomplete, and the first visual may be completed when the first mates key is joined with at least one further mates key, thereby forming a second visual. The second visual, formed when two or more corresponding mates keys are mated together, may provide an indication to the users of the mates keys that the keys come from a common source, belong to a set, and/or share a common purpose. In some embodiments, the complete visual may additionally, or alternatively, include information about the source and/or purpose of the mates keys. The visual on the bow may not affect the functionality of the key, and the bow may be attached to a functional key blade.

With reference to FIG. 2A, there is illustrated a first embodiment of a set of mates keys 200. The set of mates keys may be bitted to open a same lock, or may be bitted to open unrelated locks. Each of the mates keys 200 comprises a respective blade portion 210, 230, and a respective bow portion 220, 240. The respective bow portions 220, 240, comprise at least one mating surface for causing the mates keys 200 to mate with one another and a ringhole 228, 248. According to the illustrated embodiment, the pair of matching keys have complementary-shaped or profiled bow portions that combines together in a unified manner More particularly, in the embodiment of mates keys 200, the bow portion 220 comprises a projecting portion 222 and a recessed portion 224; similarly, the bow portion 240 comprises a projecting portion 242 and a recessed portion 244. In this particular embodiment, the projecting portion 222 is curved and is configured to mate with the recessed portion 244, which has an inverse matching curve, and the projecting portion 242 is configured to mate with the recessed portion 224 in similar fashion, causing the mates keys 200 to mate with one another. Also, each one of the pair of matching keys may have part of a picture on it such that when joined together, the pair of keys produce a complete picture. According to the illustrated embodiment, once mated, the bow portions 220, 240 form a visual of a pond or other suitable pool of water with a pair of koi fish located therein where the pair of koi fish appear to be circling each other in a pattern which may resemble a ying-yang symbol.

With reference to FIG. 2B, there is illustrated another embodiment of a set of mates keys, namely mates keys 250. Each of the mates keys 250 comprises a respective blade portion 260, 280, and a respective bow portion 270, 290 shaped like half of a heart shape. The respective bow portions 270, 290, comprise at least one mating surface for causing the mates keys 250 to mate with one another, the bow portions 270, 290 forming a complete heart shape when the two matching keys join as mates and a ringhole 278, 298. The ringholes 278, 298 may also form part of the complete visual of the mates keys 250, as in this particular embodiment, as they are heart-shaped. In the embodiment of mates keys 250, the bow portion 270 comprises a projecting portion 272 and a recessed portion 274; similarly, the bow portion 290 comprises a projecting portion 292 and a recessed portion 294. In this particular embodiment, the shape of the projection portion 272 (and its corresponding recessed portion 294) differs from the shape of the projection portion 292 (and its corresponding recessed portion 274). Moreover, in this particular embodiment, the projecting portion 272 is configured to mate with the recessed portion 294, and the projecting portion 292 is configured to mate with the recessed portion 274, causing the mates keys 250 to mate with one another. As mentioned hereinabove, once mated, the bow portions 270, 290 may form a visual of a complete heart shape.

Mates keys 200 and 250 may feature corresponding mating surfaces on respective bow portions 220, 240, 270, 290 which may be substantially curved mating surfaces, though other types of mating surfaces, as discussed hereinbelow, are also considered, including jagged surfaces, oblique surfaces, and the like. Moreover, in other embodiments the mates keys may feature corresponding bow portions which are wholly or partially symmetrical, as two halves forming a larger or more complete visual.

With reference now to FIG. 3A, there is shown another embodiment of a set of mates keys, namely mates keys 300. Here, each of the mates keys 300 comprises a respective blade portion 310, 330, and a respective bow portion 320, 340. The bow portion 320 has a butterfly-and-flower visual, whereas the bow portion 340 has a flower visual. The butterfly visual may consist of a butterfly shape blanked, milled, or coined into the bow portion 320 and with a corresponding butterfly image apply to it. Likewise, the flower visual may consist of a flower shape blanked, milled, or coined in the bow portion 340 of the other one of the mates keys 300 with a floral image printed or otherwise suitably applied to it. The butterfly and flower visual may be provided in the form of a printed image or in the form of a shape blanked, milled, or coined into a mates key and not necessarily in a combination of both. It is thus not limited to a contoured shape with a printed image as illustrated in FIG. 3A. According to the illustrated embodiment, the mates keys 300 may comprise corresponding S-shaped mating surfaces 322, 342, which are located on the bow portions 320, 340, respectively, configured to mate with one another. Additionally, the mates keys 300 may comprise complementary peak-and-trough mating surfaces 324, 344 respectively located on the bow portions 320, 340, configured to mate with one another. When mated, bow portions 320, 340 of mates keys 300 combine to form an complete visual of a butterfly on bow portion 320 approaching and/or pollinating a flower on bow portion 340.

With reference to FIG. 3B, there is shown another embodiment of a set of mates keys, specifically mates keys 350. Here, each of the mates keys 350 comprises a respective blade portion 360, 380, and a respective bow portion 370, 390, with one of the mates keys 350 having an crescent moon visual, and the other one of the mates keys 350 having a sun visual. In this embodiment, the mates keys 350 may comprise corresponding V-shaped peak-and-trough mating surfaces 374, 394, which are located on the bow portions 370, 390, respectively, configured to mate with one another. These may be, as in the present case, a nose-like part of the crescent moon-shaped bow portion 370 and an inlet made in the sun-shaped bow portion 390. Additionally, the mates keys 350 may comprise complementary curved mating surfaces 372, 392 respectively located on the bow portions 370, 390, configured to mate with one another. When mated, bow portions 370, 390 of mates keys 350 combine to form an complete visual of sun and moon.

In some embodiments, for example the mates keys 350, it is possible for the mates keys 350 to be mateable in more than one orientation. Specifically, while FIG. 3B shows the mates keys 350 mating with peak mating surface 374 mating with trough mating surface 394, it may also be possible for peak mating surface 374 to mate with trough mating surface 396, located substantively opposite trough mating surface 394. To this end, any visuals present on any of the mates keys, for example mates keys 350, are printed or otherwise applied to both a front side and a reverse side (not illustrated) of the mates keys.

Mates keys 300 and 350 may feature corresponding mating surfaces on respective bow portions 320, 340, 370, 390 which may be configured as complimentary peaks and troughs where the peak is mateable with the trough. Additionally, the mates keys 300 and 350 may feature corresponding bow portions 320, 340, and 370, 390 which are asymmetrical and, when mated, complete a larger or more complete image.

With reference to FIG. 4, there is shown a set of mates keys 400 each comprising respective blade portions 410 and bow portions 420. In this embodiment, the bow portions 420 are shaped like puzzle pieces, and each comprises at least one tab 422 and one slot 424, with the tab 422 of a first of the mates keys 400 being configured to mate with a second of the mates keys 400 by sliding, snapping, or otherwise fitting into the slot 424 of the second of the mates keys 400. In some embodiments, the ringhole 426 may also constitute a tab, and there may be provided a recessed area 428 in the bow portion which constitutes a slot; in such embodiment, the bow portions 420 comprise two tabs 422, 426, and two slots, 424, 428. This may allow for the mates keys 400 to be mated at a plurality of different orientations for forming a larger or more complex complete visual. The orientations may include having the blade portions 410 align in a given direction, having the blade portions 410 at right angles from one another, or any other suitable orientation. In embodiments where the bow portions 420 feature the recessed area 428, the mates keys 400 may also be stackable on top and/or below one-another, in addition to side-by-side, where at least part of a bow portion 420 of a first of the mates keys 400 is placed on top of, or below, at least part of a bow portion of a second of the mates keys 400. Thus, in certain embodiments the mates keys are stackable in three-dimensions.

A third of the mates keys 400 may also mate with either the first or the second of the mates keys by way of the slots 424, 428 or the tabs 422, 426, respectively of the third of the mates keys 400. In some embodiments, any suitable number of mates keys 400 may be mated together in this fashion. This may allow for the mates keys 400 to be mated together to form a larger visual, for example a jigsaw puzzle-like shape. Each matching key may be of a different color or may have part of an image applied thereon for forming a larger or complete visual when the keys are assembled together

Some sets of mates keys, for example mates keys 400, may comprise a plurality of keys, including more than two keys, configured to be mated together. In some cases, the tabs 422, 426 and slots 424, 428 may exhibit a certain degree of symmetry, such that the particular orientation of mates keys 400 is not material to two or more such mates keys mating to one another. In other cases, the tabs 422, 426 and slots 424, 428 may, by their particular configuration, require a certain orientation in order to mate, for example requiring that all the blades 410 be oriented in a common direction, and the like.

In some embodiments, a plurality of sets of mates keys may share common corresponding mating surfaces, such that a first key from a first set of mates keys may be mateable with a first key from a second set of mates keys. Put differently, different sets of mates keys, with mates keys featuring different incomplete visuals, may nevertheless have corresponding mating surfaces, which may allow a user to “mix-and-match” mates keys from different sets of mates keys. Thus, when mated, they form a custom visual of the user's choosing and design. For example, and with reference again to FIG. 2A, there may exist a first set of mates keys 200 which, as depicted in FIG. 2A, feature a visual of koi fish swimming in a pond. There may also exist a second set of mates keys which may have a bow portion shaped substantively identically to the bow portion of mates keys 200, but which feature another type of fish, for example salmon, trout, tuna, or any other suitable fish, swimming in a pond. A user may choose to create a custom complete visual by mating a first mates key 200 with a second mates key from the second set of mates keys.

In some embodiments, the bow portion of a mates key may be detachable from the blade (or vice-versa), allowing a user to change the bow portion of a particular mates key. Using the embodiment depicted in FIG. 4, a user may desire to use a mates key 400 having a blade of a first colour or design and a bow of a second colour or design different from the first colour or design. In some such embodiments, the bow portions 420 of the mates keys 400 may be detachable from the blade portion 410 to allow a user to mix-and-match designs and create their own mates keys designs.

In some embodiments, a bow for a mates key can be packaged and/or sold separately from a blade for the mates key. Thus, a mates key bow which can be physically and removably mated together with another mates key bow by way of mating surfaces the respective bow portions are also considered. The mates key bows can be substantially similar to the mates key bows of the mates keys described hereinabove. In certain embodiments, the mates key bow has a first visual located thereon and optionally includes a connector for joining the mates key bow to a blade portion. The connector can be any suitable connector which allows a key blade to be attached, removably or not, to the mates key bow, and can be a snap connector, a sliding connector, a force-fit connector, or any other kind of connector. The mates key bow also has at least one mating surface for physically mating with at least one corresponding mating surface of a corresponding mates key bow to form a second visual, as described hereinabove.

Although the preceding embodiments relate primarily to keys having blades (sometimes referred to as pin tumbler lock keys), mates keys can also be made from lever lock keys, bitted keys, tubular keys, abloy keys, dimple keys, Zeiss keys, magnetic keys, or any other suitable type of key. Mates keys include keys that are milled and unmilled keys. Further, in embodiments where the mates key bow is considered separately from the key blade, the mates key bow may be a medallion. Additionally, the designs shown in FIGS. 2A-B, 3A-B, and 4 are not to be construed as limiting, as other designs and embodiments of the mates keys are also considered

The scope of the following claims should not be limited by the preferred embodiments set forth in the examples, but should be given the broadest reasonable interpretation consistent with the description as a whole.

What is claimed is:

1. A mates key, comprising:
a blade portion; and
a bow portion connected to the blade portion and comprising a first visual, the bow portion defining at least one mating surface configured for physically mating with at least one corresponding mating surface of a corresponding bow portion of a second mates key;
the bow portion of the mates key and the corresponding bow portion of the second mates key forming a second visual, including the first visual, when physically mated.

2. The mates key of claim 1, wherein the at least one mating surface comprises a curved projection and the corresponding mating surface comprises a complementary curved recess.

3. The mates key of claim 1, wherein the at least one mating surface comprises a peak and the corresponding mating surface comprises a complementary trough.

4. The mates key of claim 1, wherein the at least one mating surface is further configured for removably mating with the at least one corresponding mating surface of the corresponding bow of the second mates key in at least two different orientations.

5. The mates key of claim 1, wherein the physically mating is effected by sliding the mating surface into the corresponding mating surface.

6. The mates key of claim 1, wherein the physically mating is effected by interlocking the mating surface with the corresponding mating surface.

7. The mates key of claim 1, wherein the physically mating is effected by snapping the mating surface into the corresponding mating surface.

8. A set of mates keys, comprising:
a plurality of mates keys including at least a first mates key and a second mates key, each of the mates key comprising:
a blade portion; and
a bow portion, connected to the blade portion, defining at least one mating surface and comprising a visual;
the at least one mating surface of the first mates key being physically mateable with a corresponding one of the at least one mating surface of the second mates key to form a second visual including at least the visual of the first mates key and the visual of the second mates key.

9. The set of mates keys of claim 8, wherein the at least one mating surface of the first mates key comprises a curved projection and the corresponding mating surface of the second mates key comprises a complementarily curved recess.

10. The set of mates keys of claim 8, wherein the at least one mating surface of the first mates key comprises a peak and the corresponding mating surface of the second mates key comprises a complementary trough.

11. The set of mates keys of claim 8, wherein the at least one mating surface of the first mates key is further configured for removably mating with the corresponding mating surface of the second mates key in at least two different orientations.

12. The set of mates keys of claim 8, wherein the physically mating is effected by sliding the at least one mating surface of the first mates key into the corresponding mating surface of the second mates key.

13. The set of mates key of claim 8, wherein the physically mating is effected by interlocking the at least one mating surface of the first mates key with the corresponding mating surface of the second mates key.

14. The set of mates keys of claim 8, wherein the physically mating is effected by snapping the at least one mating surface of the first mates key into the corresponding mating surface of the second mates key.

15. The set of mates keys of claim 8, wherein the second visual is a custom visual, and wherein the visual of the first mates key is unrelated to the visual of the second mates key.

16. A mates key bow, comprising:
a first visual located on the mates key bow; and
at least one mating surface configured for physically mating with at least one corresponding mating surface of a corresponding mates key bow to form a second visual, including the first visual, when physically mated.

17. The mates key bow of claim 16, further comprising a connector for joining the mates key bow to a blade portion.

18. The mates key bow of claim 16, wherein the physically mating is effected by sliding the mating surface into the corresponding mating surface.

19. The mates key bow of claim 16, wherein the physically mating is effected by interlocking the mating surface with the corresponding mating surface.

20. The mates key bow of claim 16, wherein the physically mating is effected by snapping the mating surface into the corresponding mating surface.
